(19) United States
(12) Patent Application Publication
(10) Pub. No.: US 2003/0088537 A1
(43) Pub. Date: May 8, 2003

(54) High speed data compression and decompression apparatus and method

(75) Inventor: Shang-Jen Ko, Portland, OR (US)

Correspondence Address: SCULLY SCOTT MURPHY & PRESSER, PC, 400 GARDEN CITY PLAZA, GARDEN CITY, NY, 11530

(73) Assignee: NEC ELUMINANT TECHNOLOGIES, INC., HERNDON, VA

(21) Appl. No.: 09/924,601

(22) Filed: Aug. 8, 2001

(51) Int. Cl. G06F 7/00

(52) U.S. Cl. 707/1

(57) ABSTRACT

A method for compressing a stream of data signals into a compressed stream of code signals is provided. The compression method including: storing strings of the data signals encountered in the stream of data signals in a dictionary, the stored strings each having a corresponding code signal; searching the stream of data signals by comparing the stream to the stored strings to determine the longest match therewith; searching the remaining stream of data signals by comparing the remaining stream to the stored strings to determine the longest match therewith; inserting into the dictionary an extended string made up of the longest match with the stream of data signals extended by the longest match with the remaining stream of said data signals; and assigning a code signal corresponding to the stored extended string.

### BACKGROUND OF THE INVENTION

1. Field of the Invention

The present invention relates generally to the field of data compression and decompression.

2. Prior Art

Data compression systems are known in the prior art that encode a stream of digital data signals into compressed digital data signals and decode the compressed digital data signals back into the original data signals. Data compression refers to any process that converts data in a given format into an alternative format having fewer bits than the original. The objective of data compression systems is to effect a savings in the amount of storage required to hold or the amount of time required to transmit a given body of digital information. The compression ratio is defined as the ratio of the length of the encoded output data to the length of the original input data. The smaller the compression ratio, the greater will be the savings in storage or time. By decreasing the required memory for data storage or the required time for data transmission, compression results in a monetary and time savings. If physical devices are utilized to store the data files, then a smaller space is required on the device for storing the compressed data. If data links are utilized for transmitting digital information, then lower costs result when the data is compressed before transmission. Data compression devices are particularly effective if the original data contains repeated patterns and/or strings. A data compression device transforms an input block of data into a more concise form and thereafter translates or decompresses the concise form back into the original data in its original format.

U.S. Pat. No. 4,558,302 to Welch, the contents of which are incorporated herein by its reference, discloses a data compressor (hereinafter referred to as “the LZW Data Compression Method”) which compresses an input stream of data byte signals by storing in a string table strings of data byte signals encountered in the input stream. Such a string table, or dictionary, links strings of data with their abbreviated representations. The compressor searches the input stream to determine the longest match to a stored string in the dictionary. Each stored string comprises a prefix string and an extension byte where the extension byte is the last byte in the stored string and the prefix string comprises all but the extension byte. Each string in the dictionary has a code signal associated therewith and a string is stored in the output by, at least implicitly, storing the code signal for the string. When the longest match between the input data byte stream and the stored strings is determined, the code signal for the longest match is transmitted as the compressed code signal for the encountered string of characters and an extension string is stored in the dictionary. The prefix of the extended string is the longest match and the extension byte of the extended string is the next input data character signal following the longest match. Searching through the string table and entering extended strings therein is effected by a limited search hashing procedure. Thus, the LZW data compression method builds its dictionary entries by appending one character at a time to existing entries. While the LZW Data Compression Method of the prior art was useful for compressing data, today's requirements for quickly transmitting large amounts of data with repeating patterns require more efficient compression methods.

The size of a dictionary in the LZW Data Compression Method of the prior art is limited by the size of its code signals. If each code signal is represented with 10 bits, the dictionary will hold 1024 entries. By increasing the size of the code signals, more code can be generated to represent longer strings. The trade-off for increasing the size of code signals is that the compressed data, which is a collection of code signals, also grows in size. Each application of LZW Data Compression typically needs to determine the optimum size of code signals. If too small, the size will result in small dictionary, and therefore, poor compression ratio; If too large, the size will result in large compressed codes, and therefore, a poor compression ratio.

### SUMMARY OF THE INVENTION

Therefore it is an object of the present invention to provide a method and apparatus for data compression and decompression which overcome the problems associated with the methods and apparatus of the prior art.

Unlike the LZW Data Compression Method of the prior art which builds each of its dictionary entries by appending one byte at a time to an existing entry, the data compression methods of the present invention build its dictionary by appending one existing entry to another existing entry, thereby providing for increased compression efficiency.

Accordingly, an apparatus for compressing a stream of data signals into a compressed stream of code signals is provided. The compression apparatus comprises: storage means for storing strings of the data signals encountered in said stream of data signals in a dictionary, said stored strings each having a corresponding code signal associated therewith; means for searching said stream of data signals by comparing said Stream to said stored strings to determine the longest match therewith; means for searching said remaining stream of data signals by comparing said remaining stream to said stored strings to determine the longest match therewith; means for inserting into said dictionary, for storage therein, an extended string comprising said longest match with said stream of data signals extended by said longest match with said remaining stream of said data signals; and means for assigning a code signal corresponding to said stored extended string.

Preferably, the compression apparatus further comprises: means for determining if said dictionary is full; and means for changing a coding size of said coding signals based on the determination of whether the dictionary is full. The coding size of said coding signals is preferably increased when it is determined that the dictionary is full. By adding one bit to the size of the coding signals, the size of the dictionary is effectively doubled.

The compression apparatus also preferably further comprises means for predefining coding signals based on the type of data signals being compressed, such as predefining the coding signals as varying length zero coding signals to represent various frequently encountered data patterns.

Also provided is a method for compressing a stream of data signals into a compressed stream of code signals. The compression method comprises: (a) storing strings of the data signals encountered in said stream of data signals in a dictionary, said stored strings each having a corresponding code signal associated therewith; (b) searching said stream of data signals by comparing said stream to said stored strings to determine the longest match therewith; (c) searching said remaining stream of data signals by comparing said remaining stream to said stored strings to determine the longest match therewith; (d) inserting into said dictionary, for storage therein, an extended string comprising said longest match with said stream of data signals extended by said longest match with said remaining stream of said data signals; and (e) assigning a code signal corresponding to said stored extended string.

Preferably, the compression method further comprises: determining if said dictionary is full; and changing a coding size of said coding signals based on the determination of whether the dictionary is full. More preferably, the coding size of said coding signals is increased when it is determined that the dictionary is full.

The compression method also preferably further comprises predefining coding signals based on the type of data signals being compressed, such as predefining the coding signals as varying length zero coding signals.

Also provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a data compression Example using the LZW data compression method of the prior art.

FIG. 2 illustrates a data decompression example using the LZW data decompression method of the prior art in which the input is the data compression result from FIG. 1.

FIG. 3 illustrates a data compression example using a preferred implementation of the data compression methods of the present invention.

FIG. 4 illustrates a data decompression example using a preferred implementation of the data decompression methods of the present invention in which the input is the data compression result from FIG. 3.

FIG. 5 illustrates an events sequence for the compression and decompression methods of FIGS. 3 and 4, respectively.

FIG. 6A illustrates a flowchart for a preferred data compression method of the present invention.

FIG. 6B illustrates a flowchart for finding the best matched code according to a preferred implementation of the present invention.

FIG. 6C illustrates a flowchart for a preferred data decompression method of the present invention.

FIG. 7 illustrates a graph showing the peak performance for the LZW data compression method as compared to the data compression methods of the present invention.

FIG. 8 illustrates a graph comparing the LZW data compression method with the data compression methods of the present invention for a first set of data.

FIG. 9 illustrates a graph comparing the LZW data compression method with the data compression methods of the present invention for second and third sets of data.

### DETAILED DESCRIPTION OF THE PREFERRED EMBODIMENT

Although this invention is applicable to numerous and various types of data, it has been found particularly useful in the environment of data with repeating patterns. Therefore, without limiting the applicability of the invention to data with repeating patterns, the invention will be described in such environment.

A glossary is provided below for the following terms in order to simplify the description of the data compression methods of the present invention:

| | |
|---|---|
| Code | a number that is used to represent a string of |
| | one or more bytes |
| String length | the number of bytes of a given string |
| Code length | the number of bytes of the string defined by |
| | a given code |
| Code size | the number of bits a code use to represent a |
| | string |
| Vocabulary | a code |
| Dictionary | a collection of codes that represent strings |
| Dictionary size | number of codes the dictionary can hold. |
| | (E.g., for 10-bit codes, the dictionary size |
| | would be 2¹⁰ = 1024) |
| EOF_CODE | a reserved code defining the end of file |
| NULL_CODE | defines the null string, same as EOF_CODE |
| One-byte codes | the first 256 codes in the dictionary (0 |
| | through 255) representing all 256 values of |
| | a byte |
| Multi-byte codes | codes that represent multi-byte strings, |
| | codes 256 and greater in the dictionary. |
| Parent code and child code | the string represented by a code is formed |
| | by appending a string to another code |
| | already defined in the dictionary, the |
| | existing code is the parent code of the newly |
| | formed code; and the newly formed code is |
| | the child code of its parent code. The string |
| | represented by the parent code is always a |
| | subset of the strings represented by the child |
| | codes. |
| Sibling codes | the codes that share the same parent code |
| | are sibling to each other |
| Append code | represents the string being appended to a |
| | parent code to form the string defined by a |
| | child code |
| Simple code | a code formed by appending a one-byte |
| | code to an existing code LZW only allows |
| | simple codes |
| Compound code | a code formed by appending a multi-byte |
| | code to an existing code. The methods of |
| | the present invention allow both simple and |
| | compound codes. |

The LZW Data Compression Method of the prior art includes a compression method for compressing a block of input data into a list of compressed codes and a decompression method for decompression of the list of decompressed codes into the original data. The basic LZW compression method is illustrated in the code of Table 1.

TABLE 1
Read the first one-byte string, CODE1
While there is input loop

Read the next input character, APPEND_CHAR
If the string CODE1+APPEND_CHAR is found in the dictionary
defined by CODE3 then

CODE1 <- CODE3

Else

Output CODE1
Add CODE1+APPEND_CHAR as a new vocabulary
to the dictionary
CODE1 <- APPEND_CHAR

End if

End loop
Output CODE1

As can be seen from Table 1, in the LZW data compression method of the prior art, data strings are defined in the dictionary (CODE1) and an append character (APPEND_CHAR) is added to the end of the next occurring data string (CODE1) to form a new dictionary definition (CODE1+APPEND_CHAR).

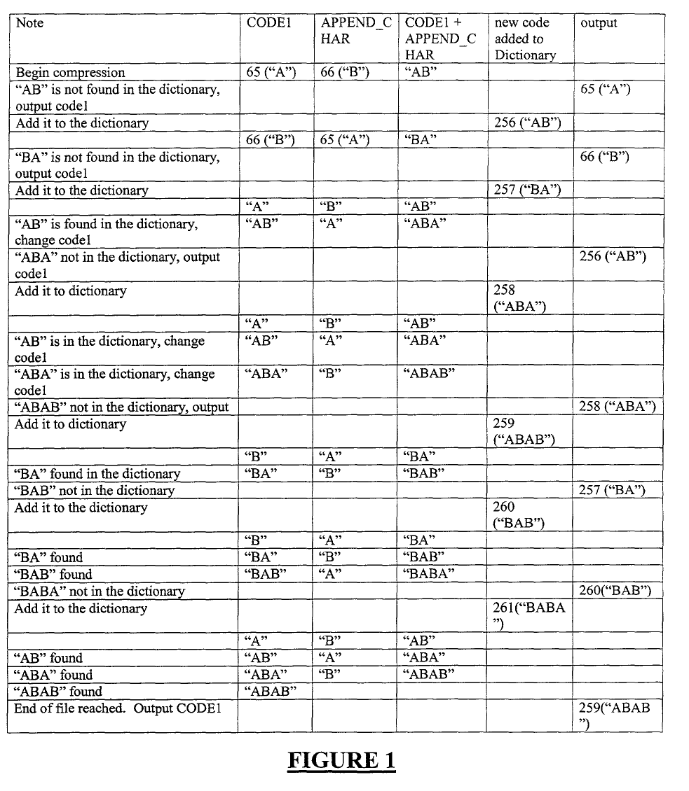

A LZW data compression example is illustrated in FIG. 1 for an input data of “ABABABABABABABAB” (“AB” repeated 8 times). As can be seen from FIG. 1, the 16-byte input is compressed into 7 codes. Assuming 10-bit codes are used, the compression ratio is (7*10)/(16*8), or 54.5%. As the data size grows, codes are more likely to represent longer and longer vocabularies, and therefore, improve the overall compression ratio.

The basic LZW decompression method is illustrated in the code of Table 2.

TABLE 2
Read the first code, CODE1

Output the one-byte string represented by CODE1
While there is input code loop

Read the next code, CODE2
If CODE2 is not in the dictionary then (special case)

STRING <- (the string represented by CODE1)::(first
character of the string represented by CODE1)

Else

STRING <- the string represented by CODE2

End if
Output STRING
Add CODE1::(first character of STRING) to the dictionary
CODE1 <- CODE2

End loop

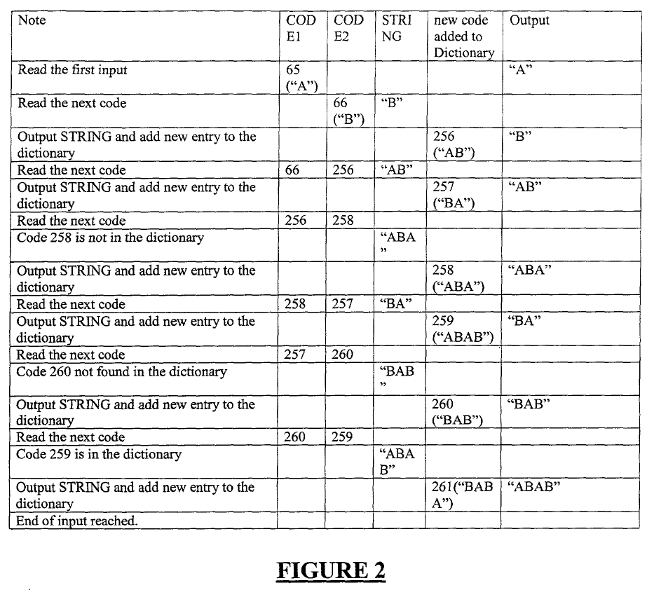

FIG. 2 illustrates an LZW decompression example where the input data is the result of the previous compression example 65-66-256-258-257-260-261, illustrated in FIG. 1. As can be seen from FIG. 2, the original data string of “ABABABABABABABAB” is reconstructed by the LZW decompression method.

In comparison to the LZW Data Compression Method discussed and illustrated above, a preferred implementation of the data compression method of the present invention is illustrated in the code of Table 3.

TABLE 3
CODE_SIZE <- 9

Read the first one-byte code, CODE1
While there is input loop

Among descendants of CODE1, find the best-matched
code and update

CODE1 to that code

Output CODE1 with CODE_SIZE number of bits
If (there is input) then

Within the remaining input, find the best-match
code, CODE2
Add the string CODE1::CODE2 to as a new vocabulary
to the dictionary
If dictionary vocabularies has reached 2^{CODE}^{_{—}}^{SIZE}
entries,

Increment CODE_SIZE

End if
CODE1 <- CODE2

End if

End loop

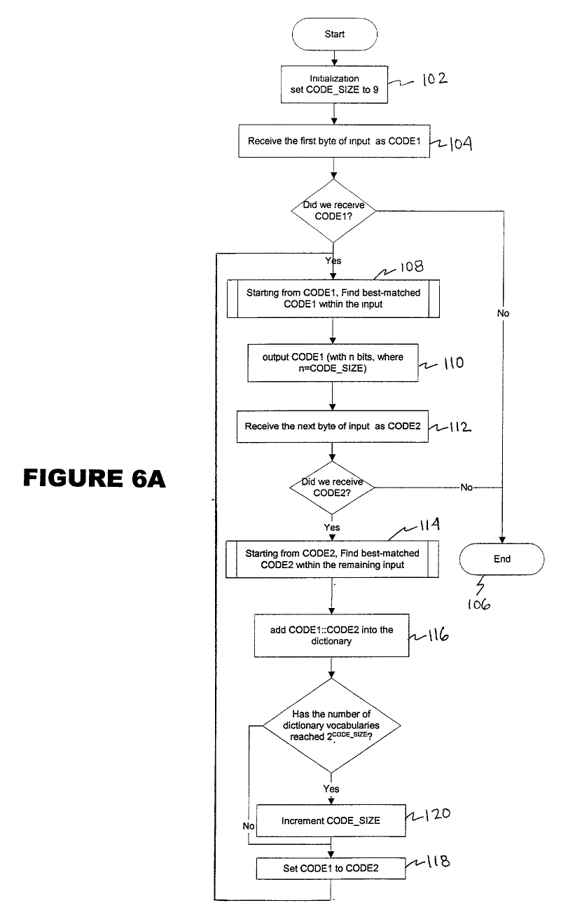

The compression method illustrated in the code of Table 3 is also illustrated with the flowchart of FIG. 6A. At step 102, the variable CODE_SIZE is preferably initialized to 9. The first byte of input in an input data stream is received at step 104 and defined by CODE1. If CODE1 is not received, the method terminates at step 106. If CODE1 is received, the data string is searched for the best matched CODE1 at step 108. Once found in the data stream, CODE1 is output at step 110, for instance to a storage device or transmitted in real time, with n-bits where n is the CODE_SIZE. The next byte of information is then received at step 112 as CODE2. If CODE2 is not received, the method terminates at step 106. If CODE2 is received, the remaining data string is searched for the best matched CODE2 at step 114 and the extended string CODE1::CODE2 is added to the dictionary at step 116. If the number of dictionary vocabularies has not reached 2^{CODE}^{_{—}}^{SIZE} CODE1 is set to CODE2 at step 118 and the method loops back to step 108. If the number of dictionary vocabularies has reached 2^{CODE}^{_{—}}^{SIZE} the CODE_SIZE is incremented at step 120 before proceeding to step 118.

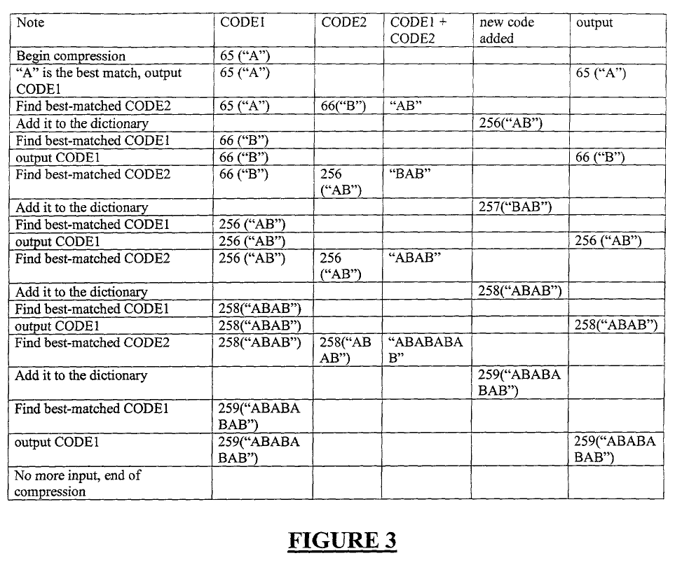

An example of the data compression method given above is illustrated in FIG. 3 using a data input of “ABABABABABABAB” (“AB” repeated 8 times). As can be seen in FIG. 3, the 16-byte input is compressed into 5 codes. Code size starts being 9 bits per code. In the example of FIG. 3, the code size never goes beyond 9 bits. Similar to the LZW Data Compression method, with the data compression methods of the present invention, as the data size grows, codes are more likely to represent longer and longer vocabularies, and therefore, improve the overall compression ratio.

Referring now to FIG. 6B, there is illustrated a flowchart showing a preferred implementation for finding the best matched code. At step 202, the compressed data is searched for CODEx which represents the first byte or the first portion of the compressed input data that can be found in the dictionary that was formed during the compression. The goal of this process is to find the longest string in the input compressed data that matches a vocabulary in the dictionary. As long as there is more input, an additional byte of input is read at step 204. All bytes received after CODEx is referred to as NEXT. If CODEx::NEXT is a subset of a vocabulary in the dictionary, and CODEx::NEXT is not a vocabulary in the dictionary, the decompression method loops back to determine if there is more input. If CODEx::NEXT is a subset of a vocabulary in the dictionary, and CODEx::NEXT is a vocabulary in the dictionary, CODEx is set to the code representing CODEx::NEXT in the dictionary at step 206 and the decompression method loops back to determine if there is more input to look for an even longer match. If CODEx::NEXT is not a subset of any vocabulary in the dictionary, then CODEx is determined to be the best match at step 208.

A preferred implementation of a data decompression method of the present invention is illustrated in the code of Table 4.

TABLE 4
CODE_SIZE <- 9
Read the first CODE_SIZE bits of code, CODE1
While (there is input) loop

Output the string represented by CODE1
Read the next code, CODE2
If CODE2 is not in the dictionary (special case)

CODE2 <- CODE1::CODE1
Add CODE2 into the dictionary

Else

Add CODE1::CODE2 to the dictionary

End if
If dictionary vocabularies has reached (2^{CODE}^{_{—}}^{SIZE}^{_{—}}1) entries,

Increment CODE_SIZE

End if
CODE1 <- CODE2

End loop
Output the string represented by CODE1

The preferred decompression method of the present invention is also illustrated in the flowchart of FIG. 6C. At step 250 CODE_SIZE is initialize to 9. At step 252 the first 9 bits of code (the compressed code) is received (this is CODE1). At step 254, it is determined if there is more input from the compression engine. If there is more input from the compression engine (254-Yes), CODE1 is decompressed at step 256 by looking up in the dictionary and outputting the string of bytes represented by CODE 1. At step 258 the next n bits of code (where n is CODE_SIZE) is read in from the compression engine, (this is CODE2). At step 260 it is determined whether CODE2 is in the dictionary. If CODE2 is in the dictionary (260-Yes), CODE1::CODE2 is added into the dictionary as the newest entry at step 262. If CODE2 is not in the dictionary (260-No), this is a special case when the compression engine uses a code that was just added into the dictionary in the compression engine but not yet added to the dictionary in the decompression engine. Therefore, at step 264 CODE1::CODE1 is added into the dictionary as the newest entry. At step 266 it is determined whether the number of dictionary entries has reached the maximum. If the number of dictionary entries has reached the maximum (266-Yes) the CODE_SIZE is incremented by one at step 268 (e.g., from 9 to 10). At step 270, CODE1 is set to the content of CODE2 and the method loops back to step 254 to determine is there is more input. If the number of dictionary entries has not reached the maximum (266-No) the method loops progresses directly to step 270. If there is no more input (254-No), CODE1 is simply decompressed at step 272 by looking up in the dictionary and outputting the string represented by CODE1.

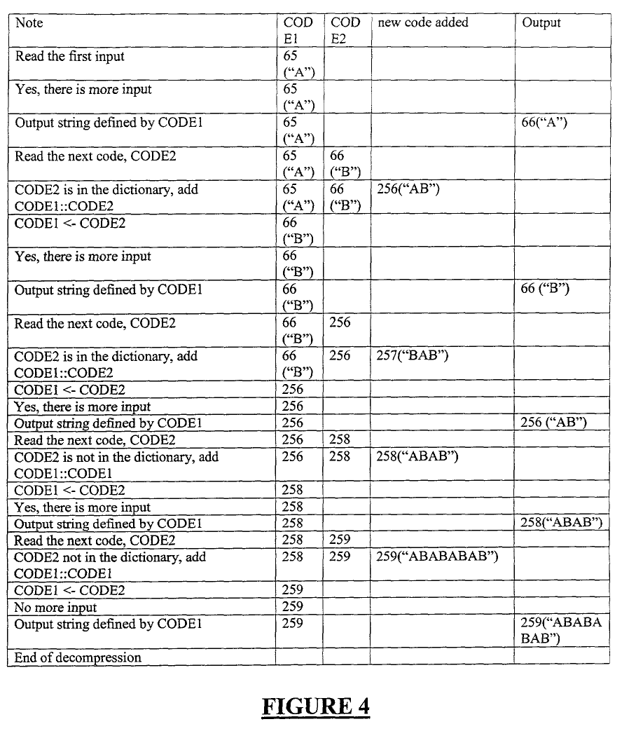

FIG. 4 illustrates a data decompression example using the data from the preferred data compression method of the present invention described above where the input data is the result of the previous compression example 65-66-256-258-259 of FIG. 3. As can be seen from the example of FIG. 4, the original data string of “ABABABABABABAB” is reconstructed. As we can see in the previous examples, the decompression engine is one step behind the compression engine in terms of generating dictionary entries.

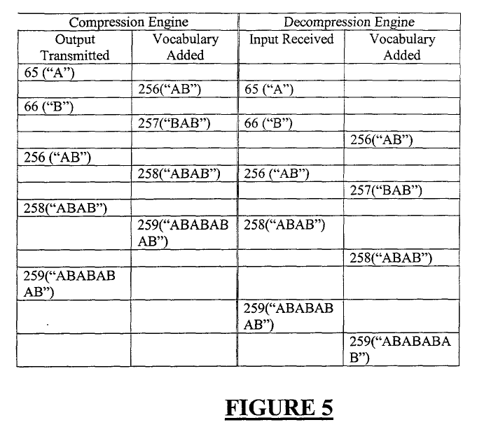

In the previous examples of FIGS. 3 and 4, the events sequence in the compression engine and the decompression engine, respectively, is listed in FIG. 5. As can be seen from FIG. 5, there are times when the compression engine sends out codes that are undefined to the decompression engine. These codes are always the next codes that the decompression engine is supposed to add to its dictionary. The only case these situations can occur is when a vocabulary that is newly-generated by the compression engine is used immediately for transmission before the decompression engine has a chance to add that vocabulary into its dictionary.

It turns out that we can prove that this newly-generated code that is unknown by the decompression engine always represents a string defined by the previously sent code repeated twice. For example, if the previous code received by the decompression engine represents the string “A_B_C” and then an undefined code is received, the undefined code will represent the string “A_B_CA_B_C”. The proof illustrated in Table 5 applies to the data compression and decompression methods of the present invention.

With this proven, it can safely be assumed that if the decompression engine receives a new code that is not yet defined in its dictionary, the new code represents the previously sent code repeated twice.

TABLE 5
Pre-conditions:
The following pre-conditions are required to made possible the
special cases when the compression engine sends a newly generated
code that is not defined by the decompression engine:
(1) If, at a given time in the compression engine, codes L and M
are both in the dictionary;
(2) If, at the same given time in the compression engine, the
remaining input to be compressed can be represented by
L: :M: :N: :(rest of the input)
(3) If, at the same given time in the compression engine, L is
represented by CODEl as the best match;
(4) If, at the same given time in the compression engine, M is
represented by CODE2 as the best match next in the input;
(5) If, at the same given time in the compression engine, a new
code NEWCODE is added to the dictionary representing L: :M
(6) If the compression engine transmits CODE1 (representing L) and
then a newly generated code NEWCODE (representing M: :N in the
input) is transmitted
We will prove:
NEWCODE = =L: :L
Proof:
(1) Based on the last pre-conditions (5) and (6) listed above, we
know that NEWCODE is generated to represent L: :M while it is also
transmitted to represent M: :N. Therefore, we know that
L: :M= =M: :N
(2) Since L: :M= =M: :N, the relationship between L and M has to be
one of the three: (a) L represents a superset of M (b) L
represents a subset of M (c) L represents the same string as M.
(For the purpose of this discussion, we do not consider equal
strings as subset / superset to each other.)
(3) Since L: :M= =M: :N. If L were a superset (descendant) of M, M
would not have been the best-matched code as pre-condition (4)
stated. (Instead, L would have been the best match in pre-
condition-4). Therefore; it is impossible for L to be a superset
of M.
(4) Since L: :M= =M: :N If L were a subset (ancestor) of M, L would
not have been the best-matched code as pre-condition (3) stated.
(Instead, M would have been the best match in pre-condition-3).
Therefore, it is impossible for L to be a subset of M.
(5) Since neither Proof (3) nor Proof(4) is true, we can conclude
that L= =M, and also, M= =N
(6) Since we know that NEWCODE represents L: :M, we have prove that
NEWCODE represents L: :L

When generating dictionary entries, having longer vocabularies (as in the case of the methods of the present invention) improves the overall compression ratio because a longer string can be represented with each code. However, with dictionaries that are full (dictionaries that can't accept an additional entry), a dictionary filled with long vocabularies usually have lower probability of matching input with its vocabularies than a dictionary filled with shorter vocabularies.

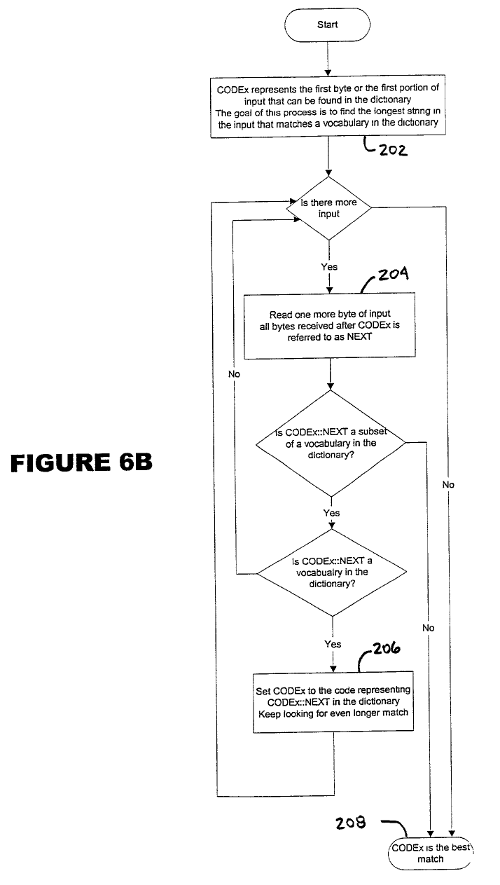

Because of the fact that the methods of the present invention tend to generate longer vocabularies than the LZW Data Compression method, the methods of the present invention yield a better compression ratio while its dictionary size is growing. However, after the dictionary is full (i.e., can't permit any new vocabulary), the LZW Data Compression method starts having a better performance because of its shorter vocabularies. FIG. 7 Illustrates a simplified estimate of the compression performances between the LZW Data Compression method and the methods of the present invention if fixed coding size is used. The peak of each compression performance shown in the graph of FIG. 7 is when the dictionary entries of each compression method are exhausted.

For this reason, it is desirable for the methods of the present invention to use a larger dictionary space to achieve a more predictable compression result. We can increase dictionary size by increasing the code size (number of bits per code). For example, if we are using 9-bit coding, there are only 512 entries in the dictionary. By increasing the code size to 14 bits per code, we can increase the dictionary size to 16384 entries. The penalty of increasing the dictionary size is, of course, the increase of size of the compressed codes. But with the use of variable-sized codes, we can avoid such penalty. The following paragraphs describe how variable-sized codes works with the methods of the present invention.

When the compression engine and decompression engine start, there are preferably only 256 pre-defined entries in their dictionaries. All codes transmitted by the compression engine will be using 9-bit coding until all 512 dictionary entries are exhausted. Right after the 513th vocabulary (code #512) is generated in the dictionary by the compression engine, all codes (0 through 1024) transmitted by the compression engine will be using 10-bit coding. On the decompression side, after the 512th vocabulary (code #511) is generated in the dictionary by the decompression engine, all codes received by the decompression engine will be decoded with 10-bit coding also. The difference in when to increment code size is the delay in dictionary generation described before.

Similarly, after the 1025th vocabulary (code 1024) is generated, the compression engine increases its code size by one. After the 1024^{th} vocabulary (code 1023) is generated, the decompression engine increases its code size by one also. The increases of code sizes continue until a predefined maximum code size is reached.

An example of how code size is changed is illustrated in Table 6 where the input is . . . (A)(B)(B)(B)(B)(B)(B)(B)(A) . . . where (A), (B) each represent a vocabulary.

TABLE 6

| Compression Engine | Decompression engine |
|---|---|
| . . . | . . . |
| Send code (A) (9-bit) | |
| Add (A): :(B) to dictionary as code #510 | |
| | Receive code (A) (9-bit) |
| | Add entry to dictionary |
| Send code (B) (9-bit) | |
| Add (B): :(B) to dictionary as code #511 | |
| | Receive code (B) (9-bit) |
| | Add (A): :(B) to dictionary |
| Send code #511 representing (B)(B) (9-bit) | |
| Add (B): :(B): :(B): :(B) to dictionary | |
| as code #512 | |
| Change CODE_SIZE to 10 | |
| | Receive code #511 (9-bit) |
| | Add (B): :(B) to dictionary |
| | as coded #511 |
| | Change CODE_SIZE to 10 |
| Send code 512 representing | |
| (B)(B)(B)(B) (10-bit) | |
| Add (B): :(B): :(B): :(B): :(A) to dictionary | |
| as code #513 | |
| | Receive code 512 (10-bit) |
| | Add (B): :(B): :(B): :(B) to |
| | dictionary as code #512 |
| Send code (A) (10-bit) | |
| | Receive code (A) (10-bit) |
| . . . | . . . |

Different source data may have different characteristics when being compressed. For example, some data contain many entries of 4-byte Boolean values while other data may contain many zero fields. For efficiency, before any compression/decompression starts, we can predefine a set of codes that we know are going to be useful. As an example, codes can be predefined that represent 2 bytes of zero through 16 bytes of zero as shown in Table 7. By predefining these codes, as is illustrated in Table 7, in both the compression engine and the decompression engine, the compression ratio is further improved.

TABLE 7

| | |
|---|---|
| Code #256 | 2 bytes of 0 |
| Code #257 | 3 bytes of 0 |
| Code #258 | 4 bytes of 0 |
| Code #259 | 5 bytes of 0 |
| Code #260 | 6 bytes of 0 |
| Code #261 | 7 bytes of 0 |
| Code #262 | 8 bytes of 0 |
| Code #263 | 9 bytes of 0 |
| Code #264 | 10 bytes of 0 |
| Code #265 | 11 bytes of 0 |
| Code #266 | 12 bytes of 0 |
| Code #267 | 13 bytes of 0 |
| Code #268 | 14 bytes of 0 |
| Code #269 | 15 bytes of 0 |
| Code #270 | 16 bytes of 0 |

As should be apparent to those skilled in the art, the main difference between the LZW Data Compression Method of the prior art and the data compression methods of the present invention is that each dictionary code in the LZW method is constructed from another dictionary code as the prefix code and one character as the append character. On the other hand, the data compression methods of the present invention allow the use of existing code as the append code, and therefore, shortening the compressed output size to achieve a better compression ratio.

In comparison, the data compression methods of the present invention builds its dictionary with longer strings, and yields a shorter output before exhausting the dictionary entries.

In one example using 564 KB of telecom database that contains the provisioning information of an SONET ADM, the LZW Data Compression Method with 14-bit coding compresses the database to 4.6% of its original size, while the data compression methods of the present invention compresses the MIB to 0.9% of its original size. The nature of such a database in the example tends to have some fields appearing in multiple locations as well as some unused fields that are often set to zeros. Such database is a good candidate for the LZW Data Compression methods as well as the data compression methods of the present invention. If the data, on the other hand, is too small or too random, the size of the compressed data may approach or even exceed the size of the original data. The LZW Data Compression methods, as well as data compression methods of the present invention, yield better results only when the input data is relatively large and contains many repeating patterns.

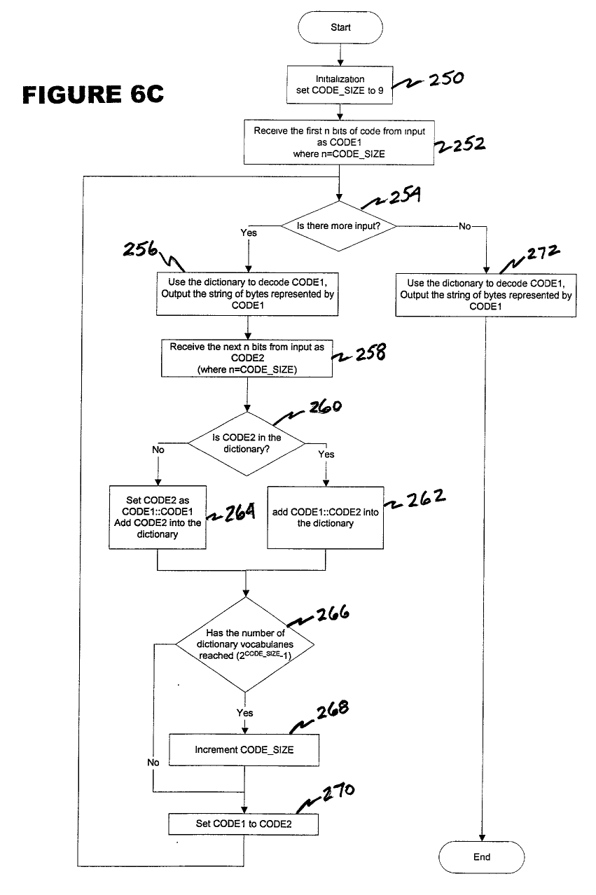

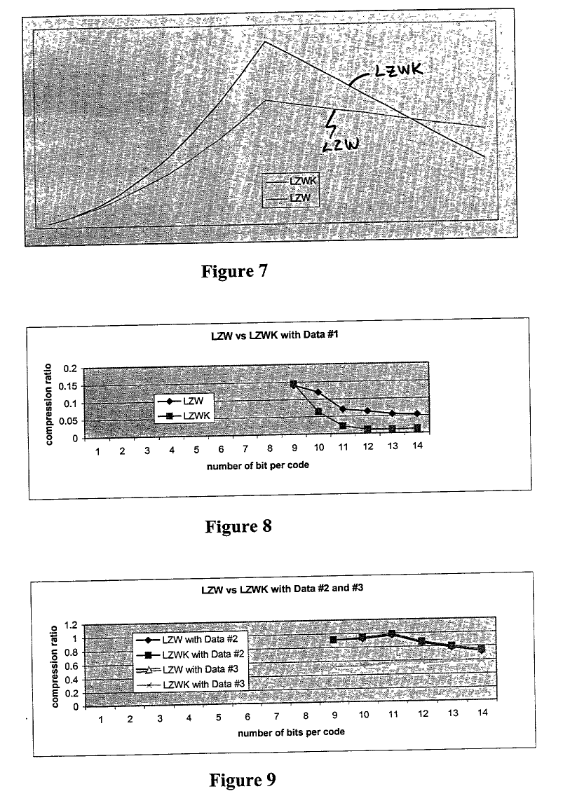

FIGS. 8 and 9 illustrate a comparison of compression performance of the LZW data compression method versus the data compression methods of the present invention (referred to in FIGS. 7, 8, and 9 as “LZWK”) when compressing three types (or sets) of 400,000-byte data. Data set #1 is illustrated in FIG. 8 and is the telecom database mentioned above that yields a very good compression result for both the LZW Data Compression method and the methods of the present invention. Data sets #2 and #3 are illustrated in FIG. 9, where data set 2 is a program code that is hardly compressible at all and data set #3 is a program data that yields a medium result.

The methods of the present invention are particularly suited to be carried out by a computer software program such as that illustrated in the Appendix, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An apparatus for compressing a stream of data signals into a compressed stream of code signals, said compression apparatus comprising:
storage means for storing strings of the data signals encountered in said stream of data signals in a dictionary, said stored strings each having a corresponding code signal associated therewith;
means for searching said stream of data signals by comparing said stream to said stored strings to determine the longest match therewith;
means for searching said remaining stream of data signals by comparing said remaining stream to said stored strings to determine the longest match therewith;
means for inserting into said dictionary, for storage therein, an extended string comprising said longest match with said stream of data signals extended by said longest match with said remaining stream of said data signals; and
means for assigning a code signal corresponding to said stored extended string.

2. The compression apparatus of claim 1, further comprising means for repeating the compression of said stream for all of the data signals therein.

3. The compression apparatus of claim 1, further comprising:
means for determining if said dictionary is full; and
means for changing a coding size of said coding signals based on the determination of whether the dictionary is full.

4. The compression apparatus of claim 3, wherein the coding size of said coding signals is increased when it is determined that the dictionary is full.

5. The compression apparatus of claim 1, further comprising means for predefining coding signals based on the type of data signals being compressed.

6. The compression apparatus of claim 5, wherein the coding signals are predefined as varying length zero coding signals.

7. A method for compressing a stream of data signals into a compressed stream of code signals, said compression method comprising:
(a) storing strings of the data signals encountered in said stream of data signals in a dictionary, said stored strings each having a corresponding code signal associated therewith;
(b) searching said stream of data signals by comparing said stream to said stored strings to determine the longest match therewith;
(c) searching said remaining stream of data signals by comparing said remaining stream to said stored strings to determine the longest match therewith;
(d) inserting into said dictionary, for storage therein, an extended string comprising said longest match with said stream of data signals extended by said longest match with said remaining stream of said data signals; and
(e) assigning a code signal corresponding to said stored extended string.

8. The compression method of claim 7, further comprising repeating steps (b) through (e) for all of the data signals in the stream.

9. The compression method of claim 7, further comprising:
determining if said dictionary is full; and
changing a coding size of said coding signals based on the determination of whether the dictionary is full.

10. The compression method of claim 9, wherein the coding size of said coding signals is increased when it is determined that the dictionary is full.

11. The compression method of claim 7, further comprising predefining coding signals based on the type of data signals being compressed.

12. The compression method of claim 11, wherein the coding signals are predefined as varying length zero coding signals.

13. A program storage device readable by machine, tangibly embodying a program of instructions executable by the machine to perform method steps for compressing a stream of data signals into a compressed stream of code signals, said method comprising:
(a) storing strings of the data signals encountered in said stream of data signals in a dictionary, said stored strings each having a corresponding code signal associated therewith;
(b) searching said stream of data signals by comparing said stream to said stored strings to determine the longest match therewith;
(c) searching said remaining stream of data signals by comparing said remaining stream to said stored strings to determine the longest match therewith;
(d) inserting into said dictionary, for storage therein, an extended string comprising said longest match with said stream of data signals extended by said longest match with said remaining stream of said data signals; and
(e) assigning a code signal corresponding to said stored extended string.

14. The program storage device of claim 13, wherein the method further comprising repeating steps (b) through (e) for all of the data signals in the stream.

15. The program storage device of claim 7, wherein the method further comprising:
determining if said dictionary is full; and
changing a coding size of said coding signals based on the determination of whether the dictionary is full.

16. The program storage device of claim 15, wherein the coding size of said coding signals is increased when it is determined that the dictionary is full.

17. The program storage device of claim 13, wherein the method further comprising predefining coding signals based on the type of data signals being compressed.

18. The program storage device of claim 11, wherein the coding signals are predefined as varying length zero coding signals.

19. A computer program product embodied in a computer-readable medium for compressing a stream of data signals into a compressed stream of code signals, said computer program product comprising:
computer readable program code means for storing strings of the data signals encountered in said stream of data signals in a dictionary, said stored strings each having a corresponding code signal associated therewith;
computer readable program code means for searching said stream of data signals by comparing said stream to said stored strings to determine the longest match therewith;
computer readable program code means for searching said remaining stream of data signals by comparing said remaining stream to said stored strings to determine the longest match therewith;
computer readable program code means for inserting into said dictionary, for storage therein, an extended string comprising said longest match with said stream of data signals extended by said longest match with said remaining stream of said data signals; and
computer readable program code means for assigning a code signal corresponding to said stored extended string.

20. The computer program product of claim 19, further comprising computer readable program code means for repeating the compression of the data stream for all of the data signals therein.

21. The computer program product of claim 19, further comprising:
computer readable program code means for determining if said dictionary is full; and
computer readable program code means for changing a coding size of said coding signals based on the determination of whether the dictionary is full.

22. The computer program product of claim 21, wherein the coding size of said coding signals is increased when it is determined that the dictionary is full.

23. The computer program product of claim 19, further comprising computer readable program code means for predefining coding signals based on the type of data signals being compressed.

24. The computer program product of claim 23, wherein the coding signals are predefined as varying length zero coding signals.
